(19) United States
(12) Patent Application Publication
(10) Pub. No.: US 2016/0179580 A1
(43) Pub. Date: Jun. 23, 2016

(54) RESOURCE MANAGEMENT BASED ON A PROCESS IDENTIFIER

(71) Applicant: HEWLETT PACKARD ENTERPRISE DEVELOPMENT L.P., Houston, TX (US)

(72) Inventor: Melvin K. BENEDICT, Houston, TX (US)

(73) Assignee: HEWLETT PACKARD ENTERPRISE DEVELOPMENT L.P., Houston, TX (US)

(21) Appl. No.: 14/902,747

(22) PCT Filed: Jul. 30, 2013
(86) PCT No.: PCT/US2013/052635

§ 371 Date: Jan. 4, 2016

(51) Int. Cl. G06F 9/50

(52) U.S. Cl. CPC G06F 9/5011; G06F 9/5016

(57) ABSTRACT

A controller may include circuitry to execute a management policy associated with a computer accessible resource based on a process identifier. The process identifier may be associated with a thread initiated by a set of instructions executed by a processor resource. The controller may be operatively coupled to a register to contain a process identifier.

### BACKGROUND

Computers and virtual machines may utilize a resource for operations, such as computation and/or communication. Resource management may commonly utilize policies to make decisions regarding access and maintenance of data associated with a request and/or a program. Controllers may be used to manage resources. For example, computer memory may be managed by a memory management unit. A controller may regulate access and use of a resource, shift data or organization of a resource, and otherwise manage the resource according to a policy. For example, the memory management unit may use a time period policy to determine if a resource request should replace a previous resource request. Resource management may improve resource efficiency and system efficiency.

### BRIEF DESCRIPTION OF THE DRAWINGS

FIGS. 1 and 2 are block diagrams depicting example resource management apparatus.

FIGS. 3 and 4 are block diagrams depicting example resource management systems.

FIGS. 5 and 6 are flow diagrams depicting example methods for managing a computer accessible resource.

### DETAILED DESCRIPTION

In the following description and figures, some example implementations of resource management apparatus, systems, and/or methods are described. Some examples are described specifically for use in a system-on-chip (“SOC”) environment and/or a virtualized environment. However, it should be noted that examples of the resource management described herein may be utilized in a wide variety of appropriate systems and applications. In particular, a resource management system may provide resource management of a system or device containing a resource while still complying with the principles disclosed herein. Therefore, SOC architectures and virtualized environments are merely two of many potential uses of the resource management apparatus, systems, and methods described herein. Thus any reference to SOC architecture and/or methods and virtualization architecture and/or methods, as well as related subject matter to SOC and virtualization, is merely included to provide context for specific examples described herein.

As resource capabilities and size improve, resources have been added to SOC architecture. The resources of the SOC may commonly be overcommitted. The resource may be managed to improve system efficiency. The system may have a predetermined or adaptable policy for managing resources. Controllers on the SOC may implement the management policy. Such management policies may commonly be based on activity level. For example, a memory management unit may use a least recently used (“LRU”) method to determine which cache entry to evict to keep entries in the cache that are being actively used.

Virtualized environments utilize virtual address space which may differ from the physical address space of the hardware of the SOC. The physical address space may be referenced by a virtual address cache directory entry where multiple physical memory locations may be used. For example, an entry may be found in the data store of the cache and may be compared to an address of the cache directory. Performance may be limited on the SOC due to various levels of cache being managed by a physical address. For example, when a first virtual machine is suspended, the resources associated with that first virtual machine may be allocated or otherwise used by a second virtual machine. When the first virtual machine returns to an active state, the resource may be reallocated to the first virtual machine. The time spent allocating, deallocating, and/or otherwise managing the resource for the virtual machine may adversely affect the efficiency of a process.

Various examples described below relate to executing management policies based on a process of the system. A system architecture that makes management decisions based on an identifier associated with a process may improve system performance and/or execution of the process. Various examples are described below by referring to several examples.

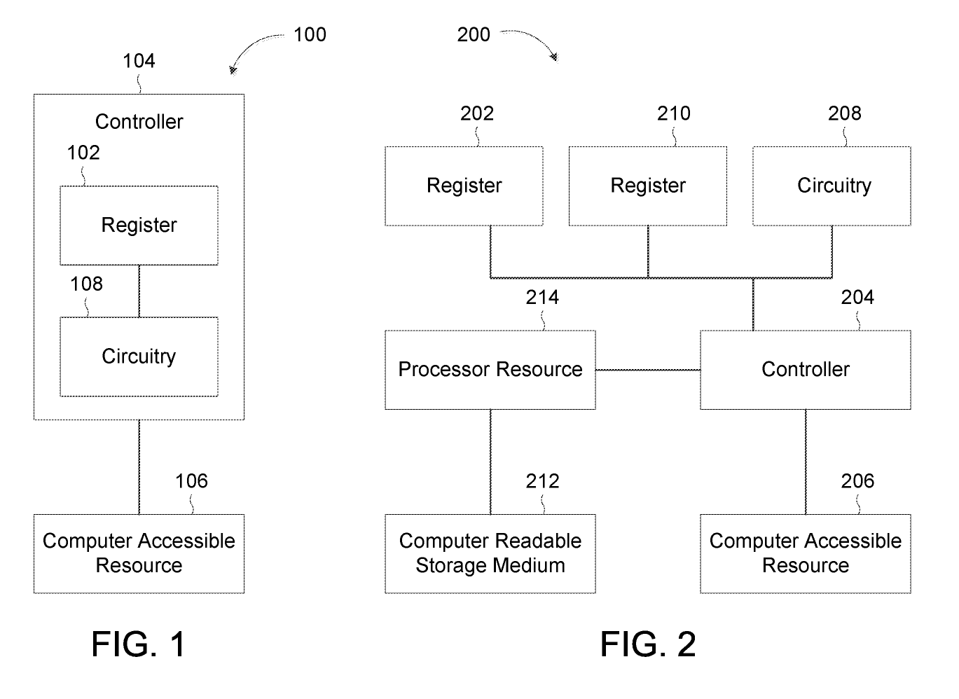

FIGS. 1 and 2 are block diagrams depicting example resource management apparatus. Referring to FIG. 1, an example resource management apparatus 100 may generally comprise a controller 104 and a computer accessible resource 106. The controller 104 may include a register 102 and a circuitry 108.

The register 102 may be a storage medium configured to contain a process identifier. For example, information of a resource table of the system may be passed to circuitry 108 to place the process identifier in a register 102. The process identifier may be associated with a thread initiated by a set of instructions executed by a processor resource. A thread may include any appropriate process executed by the processor resource. For example, a virtual machine may initiate a thread upon request of execution of an application process or a system process on a processor resource, such as processor resource 206 of FIG. 2.

The register 102 may be any appropriate register associated with computing configured to contain a process identifier. For example, the register 102 may include any appropriate example of the following configured to contain a process identifier: a data register, an address register, a conditional register, a general purpose register, a user-accessible register, a conditional register, a floating point register, a constant register, a vector register, an architectural-specific or otherwise special purpose register, a control register, a status register, a register associated with fetching information, or any appropriate combination of the registers mentioned above.

The controller 104 may be operatively coupled to the register 102. The controller 104 may include circuitry 108 to execute a management policy associated with a computer accessible resource 106 based on a process identifier. The register 102 may be contained within the controller 104 and may be part of the circuitry 108, or otherwise electrically coupled to the circuitry 108.

The controller 104 may be a chip, device, and/or circuitry that interfaces with the computer accessible resource 106. The controller 104 may be a link between components of a device or on a component that manages operation of the device. For example, the controller 104 may be attached to a communication channel, such as a bus. For another example, the controller 104 may be integrated into a device, a chip containing a system, and/or a resource. The controller 106 may be designated to control, or manage, a resource and/or transfer data between resources. For example, the controller 106 may be one of a core controller, cache controller, a memory management unit, and an input-output management unit. Other examples of a controller 104 may include a graphics controller, a network controller, a parallel port controller, a keyboard controller, a programmable interrupt controller, a receiver or transmitter controller, a direct memory access (“DMA”) controller, and a disk controller.

The computer accessible resource 106 may be any appropriate component of a computer, a SOC, or other system used in computation or otherwise associated with processes of the computer or SOC architecture. For example, the computer accessible resource 106 may be at least one of a processor resource, a memory resource, a network resource, and a peripheral resource. Other examples of a computer accessible resource 106 may include a processor, a processor core, memory, cache, a graphics card, a network card, a keyboard, receiver, transmitter, disk drive, storage medium, or other medium. The computer accessible resource 106 may be internal or external to the computing system. The computer accessible resource 106 may include virtual resources such as files or network connections.

The computer accessible resource 106 may be accessible by an address. The address may be physical or virtual. The controller 104 may use a cache, buffer, or other circuitry to translate a virtual address to a physical address on the computer accessible resource 106. For example, the controller 104 may use a translation lookaside buffer (“TLB”) to translate a virtual address to a physical address of the resource.

The management policy may be any appropriate policy for managing the computer accessible resource 106 or otherwise performing a task of the controller. The controller may be configured to include policies regarding access to the computer accessible resource 106. For example, the controller may restrict access to an address of the computer accessible resource 106 or translate an address to the computer accessible resource 106. The management policy may be a non-access policy that may make a management determination other than functions for address translation, address restriction, or otherwise accessing the computer accessible resource 106. For example, a non-access management policy may include allocation of the resource, refreshing an entry of the resource, evicting an entry of the resource, or otherwise organizing, controlling or managing the resource and the interactions with the resource. The management policy may include at least one of an allocation policy, an eviction policy, a replacement policy, and a directory policy. An allocation policy may assign or otherwise allocate a portion of the computer accessible resource 106. An eviction policy may evict or otherwise remove a set of data from the computer accessible resource 106. A replacement policy may refresh or otherwise replace a set of data of the computer accessible resource 106. The directory policy may order or otherwise organize the directory structure of the computer accessible resource 106. Memory efficiency and protection may result from the management policy based on a process identifier.

The circuitry 108 may be configured to execute a management policy based on a process identifier. The circuitry 108 may execute a management policy that is used to manage an event associated with the computer accessible resource 106 based on a process identifier. An event may be any appropriate action to facilitate use of the computer accessible resource 106. For example, an event may include an allocation of a portion of the computer accessible resource 106, an eviction of a set of data from the computer accessible resource 106, a refresh of a set of data contained in the computer accessible resource 106, a change in directory structure of the computer accessible resource 106. The events may be scheduled based on priority and the priority may be based on a process identifier. The circuitry 108 may be any appropriate combination of logical components to manage a resource based on the process identifier. For example, the circuitry 108 may be a combination of logical components to translate a virtual address to a physical address and to execute a non-access policy on the computer accessible resource 106 at the physical address based on the process identifier. In that example, the register 102 may receive the process identifier from a page table entry or any other appropriate method of providing the process identifier to the register 102 to execute the management policy based on the process identifier.

The circuitry 108 may be composed of electronic components connected by conductive wires to perform a task of the management policy. For example, the controller 104 may receive information regarding the process identifier and/or thread using the computer accessible resource 106, that information may be placed into a register 102 connected to logical components and wires to make a policy determination with regards to the information. The circuitry 108 may be analog, digital, or a combination thereof. The circuitry 108 may include resistors, transistors, capacitors, inductors, and/or diodes. The circuitry 108 may include logical components, or gates, to provide functions and/or logic, such as Boolean logic. For example, the circuitry 108 may include a comparator between two registers, such as registers 202 and 210 of FIG. 2, to compare the values of the registers and a gate to make a policy determination based on the comparison result.

Referring to FIG. 2, the resource management apparatus may generally comprise a computer accessible resource 206, a controller 204, a circuitry 208, a first register 202, a second register 210, a processor resource 214, and a computer readable storage medium 212. The computer accessible resource 206 may be the same as the computer accessible resource 106 of FIG. 1 and the description associated with the computer accessible resource 106 may be applied to the computer accessible resource 206. The controller 204 may be the same as the controller 104 of FIG. 1 and the description associated with the controller 104 may be applied to the controller 204. The circuitry 208 may be the same as the circuitry 108 of FIG. 1 and the description associated with the circuitry 108 may be applied to the circuitry 208. The first register 202 may be the same as the register 102 of FIG. 1 and the description associated with the register 102 may be applied to the first register 202. The description of register 102 of FIG. 1, unless described otherwise, may also apply to second register 210.

The computer accessible resource 206 may be operatively coupled to the controller 204. The controller 204 may include circuitry 208 operatively coupled to the first register 202 and the second register 210. The circuitry 208 may be configured to execute a management policy based on a result of a comparison between the first register 202 and the second register 210, where the comparison includes an identifier of a process in one of the registers 202 and 210.

The processor resource 214 may be operatively coupled to the controller 204 and the computer readable storage medium 212. The computer readable storage medium 212 may contain a set of instructions. The processor resource 214 may be configured to execute a set of instructions contained on the computer readable storage medium 212. The processor resource 214 may carry out the set of instructions to request the controller 204 execute a management policy and maintain the computer accessible resource 206 based on the management policy and the process identifier.

The management policy may determine to manage the computer accessible resource 206 based on the process identifier. The management determination may be based on a function and/or circuitry 208 between a first register 202 containing a process identifier and a second register 210 containing a request identifier. The result of that function and/or circuitry 208 may be the computer accessible resource 206 has had a management operation performed on the computer accessible resource 206. For example, a portion of the computer accessible resource 206 may be allocated to a process identifier or the directory structure of the computer accessible resource 206 may be organized based on the process identifier.

The second register 210 may be coupled to the controller 204. The second register 210 may be configured to contain an entry of a table. The circuitry 208 of the controller 204 may compare the first register 202 to the second register 210. The circuitry 208 may execute the management policy based on the comparison of the first register 202 and the second register 210. For example, the management policy may include an eviction policy that compares the entries of the first register 202 containing a process identifier of a high priority process and the second register 210 containing the identifier associated with the address of the resource and if the entries match, the circuitry 208 may decide to not evict the data contained at that memory address and may move on to the next address of the memory resource to search for data to evict.

The second register 210 may be operatively coupled to an additional controller, an additional resource, or an additional circuitry. For example, the second register 210 may be coupled to a TLB, such as the TLB 430 of FIG. 4, to receive an entry or other information associated with a table, such as a page table entry or a resource table. In that example, the TLB may be operatively coupled to the second register 210 and associated with the table. The second register 210 and the first register 202 may facilitate execution of the management policy by the controller 204.

The management policy may include non-access policies, or policies separate from determining whether the requested computer accessible resource 206, or a portion thereof, is accessible or inaccessible. The controller 204 may execute circuitry 208 to manage the computer accessible resource 206 based on the process identifier separate from whether the thread associated with the process identifier may access the computer accessible resource 206. For example, a first thread of a first virtual machine may not be allowed access, at the time of the request, to a computer accessible resource 206 containing instructions or data of a second thread executed by a second virtual machine, however, the management policy may organize the cache structure based on the process identifier associated with the first thread to accommodate cache requests of the first thread or evict instructions or data cached by the first thread.

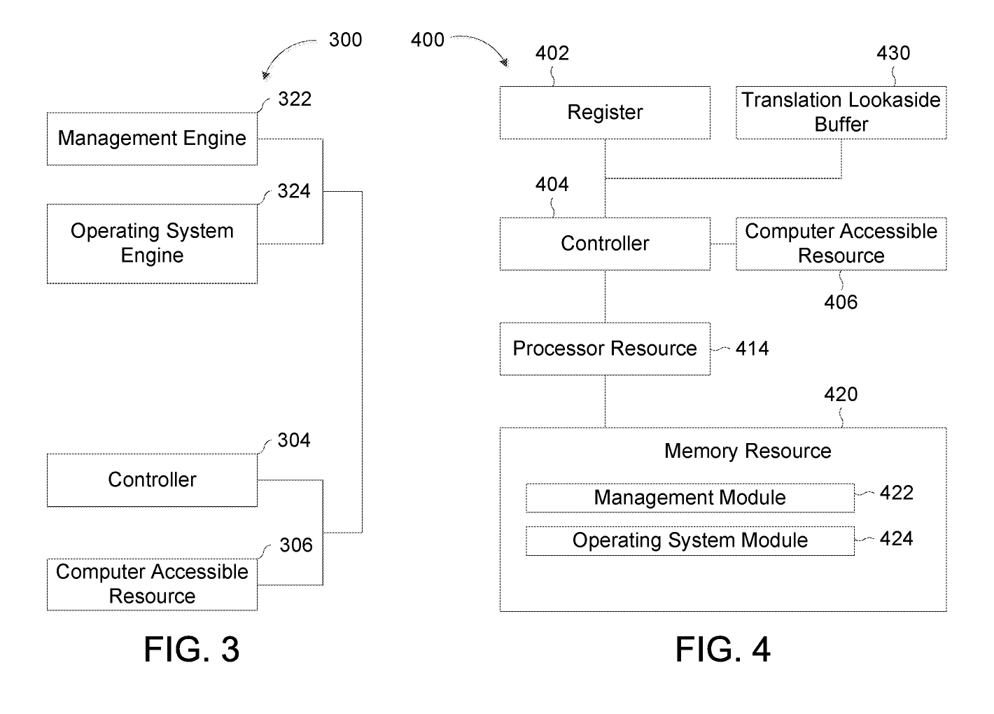

FIGS. 3 and 4 are block diagrams depicting example resource management systems. FIGS. 3 and 4 depict examples of physical and logical components for implementing various examples. FIG. 3 depicts an example of the resource management system 300 that may generally include a controller 304 and a computer accessible resource 306. The example resource management system 300 may also include a management engine 312, and an operating system engine 314. The computer accessible resource 306 may be the same as the computer accessible resource 106 of FIG. 1 and/or the computer accessible resource 206 of FIG. 2 and the description associated with the computer accessible resources 106 and 206 may be applied to the computer accessible resource 306. The controller 304 may be the same as the controller 104 of FIG. 1 and/or the controller 204 of FIG. 2 and the description associated with the controllers 104 and 204 may be applied to the controller 304.

The computer accessible resource 306 may include any appropriate combination of hardware and programming configured to communicate and/or store data.

The controller 304 may include any appropriate combination of hardware and programming configured to manage a computer accessible resource 306. The controller 304 may be associated with the computer accessible resource 306 and may have circuitry, such as the circuitry 108 of FIG. 1 or the circuitry 208 of FIG. 2, to execute a management policy based on a process identifier. The controller 304 may contain or otherwise be operatively coupled to a register, such as the register 102 of FIG. 1 or the register 202 of FIG. 2, configured to store the process identifier.

The management engine 312 may include any appropriate combination of hardware and programming configured to provide and/or maintain a management policy. The management engine 312 may be operatively coupled to the controller 304. The management engine 312 may provide a management policy to the controller 304 and the controller 304 may implement the management policy. For example, the controller 304 may be programmable and/or otherwise may receive instructions from the management engine 312 to at least one of update the management policy and execute a management operation based on a process identifier. The management engine 312 may provide a management policy that may include at least one of an allocation policy to allocate a portion of the computer accessible resource, an eviction policy to remove a set of data from the computer accessible resource, a replacement policy to refresh the set of data contained in the computer accessible resource, and a directory policy to order the directory structure of the computer accessible resource. For example, the management engine 312 may provide instructions to the controller 304 and the controller 304 may at least one of allocate a portion of the computer accessible resource 306 based on the process identifier, remove a set of data from the computer accessible resource 306 based on the process identifier, and maintain an order of the set of data of the computer accessible resource 306 based on the process identifier. The management policy may define an event priority associated with the computer accessible resource 306 based on the process identifier. A policy may include an event priority that determines and/or otherwise defines the priority of an event scheduled to act on or otherwise manage the computer accessible resource 306 based on a process identifier. For example, a process identifier may be given high priority and the management policy may determine that, at any given time, allocations associated with that process identifier be made first, evictions associated with that process be made last, and the refresh rate associated with process identifier maybe more frequent than refresh rates of other data.

The operating system engine 314 may include any appropriate combination of hardware and programming configured to maintain a thread and manage a request for resources from that thread. The operating system engine 314 may execute a management request associated with a memory address. For example, the operating system engine 314 may request allocation of a memory address to a thread or may evict a cache entry of the memory address associated with the process identifier. The management request may originate from a thread created and/or processed by an operating system. The operating system engine 314 may provide management of a memory address based on a virtual addressing scheme and the process identifier.

The operating system engine 314 may create and maintain a page table to store a mapping between a virtual address and a physical address. For example, a thread on a virtual machine may initiate a management request at a virtual address and the page table may be used to translate the virtual address to a physical address of the computer accessible resource 306. The page table may be a table or any other appropriate data structure usable by an operating system to store an address map. The page table may include entries associated with computation requests, resource requests, and other instructions processed by a processor resource. The page table may include information associated with a thread. More particularly, an entry of the page table may be reserved for a process identifier associated with the thread requesting the instruction be performed. The operating system engine 314 may create a page table entry having a request identifier associated with the management request. For example, a thread may request allocation of a memory resource and the process identifier associated with the thread may be added to the page table entry associated with the allocation request. The page table entry may be passed to the controller for processing the management policy.

The operating system engine 314 may be operatively coupled to the management engine 312. The operating system engine 314 may determine the management policy provided by the management engine 314. For example, the operating system engine 314 may provide an interface to the management engine 312 to change an allocation policy based on a process identifier of a thread created and/or processed by the operating system.

FIG. 4 depicts the resource management system 400 may be implemented on a memory resource 420 operatively coupled to a processor resource 414. The processor resource 414 may be operatively coupled to a controller 404. The computer accessible resource 406 may be the same as the previously described computer accessible resources 106, 206, and 306 and the description associated with the computer accessible resources 106, 206, and 306 may be applied to the computer accessible resource 406 and vice versa. The controller 404 may be the same as the previously described controllers 104, 204, and 304 and the description associated with the controllers 104, 204, and 304 may be applied to the controller 404 and vice versa. The processor resource 414 may be the same as the processor resource 214 of FIG. 2 and the description associated with the processor resource 214 may be applied to the processor resource 414 and vice versa.

The memory resource 420 may contain a set of instructions. The processor resource 414 may carry out the set of instructions to cause the controller 404 to execute the management policy and manage the computer accessible resource 406 based on the management policy and the process identifier. The processor resource 414 may carry out the set of instructions to complete or assist completion of an operation discussed in reference to the engines 312 and 314 of FIG. 3. For example, the processor resource 414 may carry out the set of instructions to determine the management policy, or receive the management policy from the operating system engine 314, and send that policy to the controller 404 for execution. The memory resource 420 may be a representation of a computer readable storage medium, such as computer readable storage medium 208 of FIG. 2.

In the example of FIG. 4, the resource management system 400 may include a memory resource 420 containing a management module 422 and an operating system engine 424. The memory resource 420 may contain a set of instructions to be carried out by the processor resource 414. The processor resource 414 may carry out the set of instruction to execute the management engine 422, the operating system engine 424, and/or any operations between or otherwise associated with the modules of the resource management system 400.

The processor resource 414 may be operatively coupled to the controller 404 and the memory resource 420. The processor resource 414 may carry out a set of instructions to request the controller 404 execute the management policy and maintain the computer accessible resource 406 based on the management policy and the process identifier. The process identifier may be associated with a thread. The thread may be executed by the processor resource 414 by a set of instructions contained on the memory resource 420.

In FIG. 4, the executable program instructions stored in memory resource 420 may be represented as the management module 422 and the operating system module 424 that when executed by the processor resource 414 may, in conjunction with the controller 404, implement the resource management system 400. The management module 422 may represent program instructions that when executed function as a management engine 312. The operating system module 424 may represent program instructions that when executed function as an operating system engine 314. The engines 312 and 314 and/or the modules 422 and 424 may be distributed across any appropriate combination of server devices, client devices, and storage mediums.

The processor resource 414 may be one or multiple central processing units (“CPU”) capable of retrieving instructions from the memory resource 420 and executing those instructions. The processor resource 414 may process the instructions serially, concurrently, or in partial concurrence, in accordance with the description herein.

The memory resource 420 of FIG. 4 and the computer readable storage medium 208 of FIG. 2 may represent a medium to store data utilized by the resource management system 400 and 200 respectively. The medium may be any appropriate non-transitory medium or combination of non-transitory mediums able to electronically store data and/or capable of storing the modules of the resource management system 400. The medium may be machine-readable, such as computer-readable.

The TLB 430 may be coupled to the controller 404. The TLB 430 may assist in translation between a virtual address and a physical address. The TLB 430 may compare the page table entry with the process identifier. The result of the comparison made by the TLB 430 may determine the execution of a management policy and/or execute the management policy. For example, if the page table entry translation matches a process identifier, the data associated with the process identifier may be evicted at a different schedule rate than data not associated with the process identifier. The TLB 430 may be configured or otherwise include circuitry, such as the circuitry 108 of FIG. 1 or the circuitry 208 of FIG. 2, to execute the management policy as described herein.

The computer accessible resource 406 may be any appropriate component, whether internal or external, that is capable of communication with circuitry, such as the circuitry 108 of FIG. 1 or the circuitry 208 of FIG. 2, associated with the controller 404. The computer accessible resource 406 may be a physical component or a virtual component. The computer accessible resource 406 may store data, such as a storage medium, or may provide data in transit, such as by signal.

In the discussion herein, engines 312 and 314 and modules 422 and 424 have been described as combinations of hardware and programming. Such components may be implemented in a number of fashions. Looking at FIG. 4, the programming may be processor executable instructions stored on the memory resource 420, which is a tangible, non-transitory computer readable storage medium, and the hardware may include processor resource 414 for executing those instructions. The processor resource 414, for example, may include one or multiple processors. Such multiple processors may be integrated in a single device or distributed across devices. For example, the processor resource 414 may be distributed across any appropriate combination of server devices and client devices. The memory resource 420 may be said to store program instructions that when executed by processor resource 414 implements the resource management system 400 in FIG. 4. The memory resource 420 may be integrated in the same device as processor resource 414 or it may be separate but accessible to that device and processor resource 414. The memory resource 420 may be distributed across devices.

In one example, the program instructions can be part of an installation package that when installed may be executed by processor resource 414 to implement the system 400. In this case, memory resource 420 may be a portable medium such as a CD, DVD, or flash drive or memory maintained by a server device from which the installation package may be downloaded and installed. In another example, the program instructions may be part of an application or applications already installed. Here, the memory resource 420 may include integrated memory such as a hard drive, solid state drive, or the like.

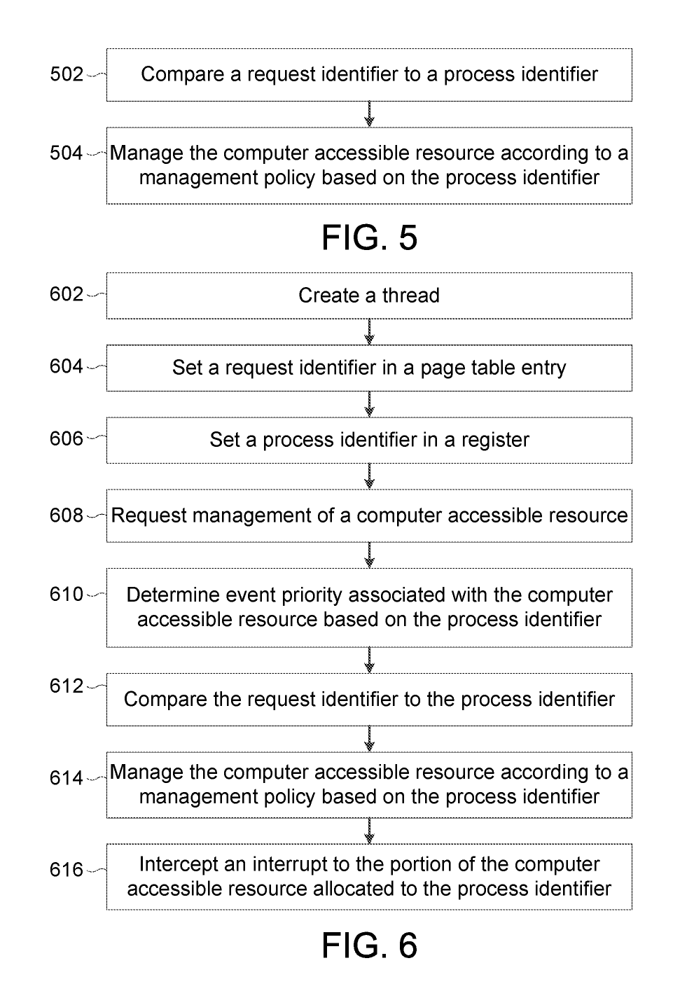

Operation: FIGS. 5 and 6 are flow diagrams depicting example methods for managing a computer accessible resource. In discussing FIGS. 5 and 6, reference may be made to elements and diagrams of FIGS. 1-4 to provide contextual examples. Implementation, however, is not limited to those examples.

In block 502, upon execution of a management request to a computer accessible resource, a request identifier may be compared to a process identifier. The request identifier may be associated with a thread that made the request or the thread to be acted upon by the management policy. The process identifier may be associated with a thread that may be associated with the computer accessible resource or the previously executed thread.

In block 504, the computer accessible resource may be managed according to a management policy based on the process identifier. For example, the management policy may include evicting data associated with the process identifier, and if the request identifier is associated with the process identifier, the data may be evicted. The management policy may be any appropriate policy associated with managing the computer accessible resource.

In block 602 of FIG. 6, a thread may be created. The thread may be initiated by a set of instructions executed by a processor resource. The thread may be apportioned a resource or otherwise request management of a resource. For example, the thread may be a high priority process and the management policy may determine that the thread be allocated a portion of L2 cache based on the request identifier and/or process identifier associated with the thread.

In block 604, a request identifier may be set in a page table entry. The request identifier may be the process identifier of the process making the request or the process identifier of the process to be affected by the request. The page table entry may include a request identifier of the thread. The page table may be updated with each request may by the thread and each update may be associated with the request identifier.

In block 606, a process identifier may be set in a register. The register may be part of a controller associated with a computer accessible resource. When a request is made to a resource, a register may be updated with the request identifier associated with the request or the process identifier of the data of the computer accessible resource.

In block 608, a management request may be made associated with a computer accessible resource. The thread, or a process, of an operating system may make a request to manage the computer accessible resource. The request may be received by the controller or a management engine that may maintain the management policy of the computer accessible resource.

In block 610, the event priority associated with the computer accessible resource may be determined based on the process identifier. The controller or the management engine may determine the event priority based on the process identifier. The computer accessible resource may receive many requests and the event priority may determine a schedule or a hierarchy of management policies. For example, a first management policy associated with a high priority process identifier may be given priority over a second management policy associated with a low priority process identifier.

In block 612, the request identifier may be compared to the process identifier. The controller may have a first register to contain the request identifier and a second register to contain the process identifier. The controller may compare the two registers. The management policy may determine the management operation based on the result of the comparison. A TLB may be used to translate the memory request using the page table entry having the request identifier and make the comparison to the process identifier. The comparison may be made upon receiving the request at the controller, during TLB translation, after translation, or any other appropriate point of a resource request.

In block 614, the computer accessible resource may be managed according to a management policy based on a process identifier. For example, management may include at least one of allocating a portion of the computer accessible resource, evicting an entry of the computer accessible resource, replacing the entry of the computer accessible resource, and adjusting a cache directory.

In block 616, an interrupt request to the portion of the computer accessible resource allocated to the process identifier may be intercepted. The management policy may determine that the computer accessible resource may be protected from management requests. For example, if a portion of the computer accessible resource was allocated to a process identifier, the controller or management engine may intercept the interrupt request.

Although the flow diagrams of FIGS. 5 and 6 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

FIGS. 1-4 depict architecture, functionality, operation of various examples, and various physical and logical components. Various components are defined at least in part as programs or programming. Each such component, portion thereof, or various combinations thereof may represent in whole or in part a module segment or portion of code that comprises an executable instruction that may implement any specified logical function(s) independently or in conjunction with additional executable instructions. Each component or various combinations thereof may represent a circuit or a number of interconnected circuits to implement the specified logical function(s).

Examples can be realized in any computer-readable medium for use by or in connection with an instruction execution system such as a computer/processor based system or an Application Specific Integrated Circuit (“ASIC”) or other system that can fetch or obtain the logic from the computer-readable medium and execute the instructions contained therein. Reduced instruction set computer (“RISC”) may commonly use simplified instructions to increase execution speed and fewer registers, commonly eight registers, in instruction execution than a complex instruction set computer (“CISC”) which may run multiple low-level instructions with a single instruction of the processor. The resource management apparatus, systems, or methods described herein may be used in a RISC architecture.

“Computer-readable medium” may be any individual medium or distinct media that may contain, store, or maintain a set of instructions and data for use by or in connection with the instruction execution system. A computer readable storage medium may comprise any one or combination of many physical, non-transitory media such as, for example, electronic, magnetic, optical, electromagnetic, or semiconductor media. Specific examples of computer-readable medium may include, but are not limited to, a portable magnetic computer diskette such as hard drives, solid state drives, random access memory (“RAM”), read-only memory (“ROM”), erasable programmable ROM, flash drives, and portable compact discs.

The present description has been shown and described with reference to the foregoing examples. It is understood, however, that other forms, details, and examples may be made without departing from the spirit and scope of the invention that is defined in the following claims.

What is claimed is:

1. A resource management apparatus comprising:
a register to contain a process identifier associated with a thread initiated by a set of instructions executed by a processor resource; and
a controller operatively coupled to the register, the controller including a circuitry to execute a management policy that is used to manage an event associated with a computer accessible resource based on the process identifier.

2. The resource management apparatus of claim 1, wherein the management policy includes at least one of an allocation policy to allocate a portion of the computer accessible resource, an eviction policy to remove a set of data from the computer accessible resource, a replacement policy to refresh the set of data contained in the computer accessible resource, and a directory policy to order the directory structure of the computer accessible resource.

3. The resource management apparatus of claim 1, wherein the controller is one of a core controller, cache controller, a memory management unit, and an input-output management unit.

4. The resource management apparatus of claim 1, comprising a second register coupled to the controller, the second register to contain an entry of a table, the circuitry to compare the register to the second register.

5. The resource management apparatus of claim 4, comprising a translation lookaside buffer, the translation lookaside buffer operatively coupled to the second register and associated with the table.

6. A resource management system comprising:
a computer accessible resource;
a controller associated with the computer accessible resource, the controller having circuitry to execute a management policy based on a process identifier associated with a thread;
and a processor resource operatively coupled to the controller and a computer readable storage medium, wherein the computer readable storage medium contains a set of instructions, the processor resource to carry out the set of instructions to:
cause the controller to execute the management policy; and
manage the computer accessible resource based on the management policy and the process identifier.

7. The resource management system of claim 6, wherein the management policy defines an event priority associated with the computer accessible resource based on the process identifier.

8. The resource management system of claim 6, further comprising a management engine to provide a management policy to the controller, the controller to at least one of:
allocate a portion of the computer accessible resource based on the process identifier;
remove a set of data from the computer accessible resource based on the process identifier; and
maintain an order of the set of data of the computer accessible resource based on the process identifier.

9. The resource management system of claim 6, comprising an operating system engine, the operating system engine to:
execute a management request associated with a memory address; and
create a page table entry having a request identifier associated with the management request.

10. The resource management system of claim 8, comprising a translation lookaside buffer coupled to the controller, the translation lookaside buffer to compare the page table entry with the process identifier.

11. A method for managing a computer accessible resource comprising:
upon execution of a management request to the computer accessible resource:
comparing a request identifier to a process identifier; and
managing the computer accessible resource according to a management policy based on the process identifier.

12. The method of claim 11, comprising
upon creation of a thread:
setting the request identifier in a page table entry, the page table entry associated with the thread; and
setting the process identifier in a register.

13. The method of claim 11, comprising determining event priority associated with the computer accessible resource based on the process identifier.

14. The method of claim 11, wherein the management policy includes at least one of:
allocating a portion of the computer accessible resource;
evicting an entry of the computer accessible resource;
replacing the entry of the computer accessible resource; and
adjusting a cache directory.

15. The method of claim 14, comprising:
allocating a portion of the computer accessible resource to the process identifier; and
intercepting an interrupt request to access the portion of the computer accessible resource.
